(19) United States
(12) Patent Application Publication
(10) Pub. No.: US 2018/0300264 A1
(43) Pub. Date: Oct. 18, 2018

(54) FUNCTION STATES OF A DEVICE COUPLED TO A COMPUTER BUS

(71) Applicant: Intel Corporation, Santa Clara, CA (US)

(72) Inventors: David J. Harriman, Portland, OR (US); Sean O. Stalley, Hillsboro, OR (US)

(21) Appl. No.: 15/706,497

(22) Filed: Sep. 15, 2017

Related U.S. Application Data
(60) Provisional application No. 62/485,316, filed on Apr. 13, 2017.

(51) Int. Cl. G06F 13/14; G06F 13/40; G06F 13/10

(52) U.S. Cl. CPC G06F 13/14; G06F 13/102; G06F 13/4063

(57) ABSTRACT

Embodiments may include systems and methods for managing a function state of a device when the device is coupled to a processor through a computer bus. An apparatus for computing may include a processor coupled to a computer bus. A system driver may be executed by the processor to identify a function state of a device based on a feedback from a function status register in the device, when the device is coupled to the computer bus. A device may include an interface to be coupled to a computer bus, and a function status register coupled to the interface. The function status register may store information to indicate a function state of the device, and the function state may be accessible by a processor coupled to the function status register through the computer bus. Other embodiments may be described and/or claimed.

### CROSS REFERENCE TO RELATED APPLICATIONS

The present application claims priority from U.S. Provisional Patent Application No. 62/485,316, filed Apr. 13, 2017, and entitled “DETERMINATION OF CONFIGURATION STATE OF A PERIPHERAL COMPONENT INTERCONNECT (PCI) FUNCTION (FUNCTION STATE REPORTING),” the entire disclosure of which is hereby incorporated by reference.

### FIELD

Embodiments herein relate generally to the technical field of communication and computing, and more particularly to a computing bus and devices coupled to the computer bus.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A computer bus is a communication system that may transfer data between devices or components inside a computer, or between computers. Devices, or components coupled to a computer bus may also be referred to as functions. A computer bus may include related hardware components (wire, optical fiber, etc.) and software, including communication protocols. There may be many kinds of computer bus, such as serial buses or parallel buses. A peripheral component interconnect (PCI) bus is a computer bus based on a specification that provides a mechanism for system software, or a system driver, to perform various operations related to the configuration of a device coupled to the PCI bus.

However, the specification for the PCI bus was developed 20 years ago, which may not meet the current computing demands. For example, a PCI bus may only provide simple states for a device coupled to the PCI bus, either ready for configuration, or not ready for configuration, without providing more information for a system driver to distinguish between detailed states. Moreover, the system driver may use a timer to determine a device coupled to a PCI bus to be in a ready for configuration state, where the system driver simply waits for the timer to expire. In addition, the system driver for a PCI bus may not handle new devices developed long after the PCI bus was developed, such as solid-state devices (SSDs). For SSDs coupled to a PCI bus, the SSDs may experience a long internal housekeeping cycle with a long delay. A system driver for the PCI bus coupled to the SSDs may not gracefully declare the SSDs unavailable for use by firmware/software during the long internal housekeeping cycle. Instead, the system driver for the PCI bus may determine a system reboot to recover the SSDs. Other limiting issues for a PCI bus may include, inconsistent and unreliable input/output (I/O) subsystem configuration, very little support for evaluating a state of a virtual device in a virtual machine (VM).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example apparatus including a processor coupled to a device by a computer bus, and a system driver to identify a function state of the device based on a feedback from the device, in accordance with various embodiments.

FIG. 2 illustrates another example apparatus including a processor coupled to a virtual device by a computer bus, and a system driver to identify a function state of the virtual device based on a feedback from the virtual device, in accordance with various embodiments.

FIG. 3 illustrates an example function status register of a device to store information to indicate a function state of the device coupled to a computer bus, in accordance with various embodiments.

FIG. 4 illustrates an example state diagram of operations to be performed by a system driver to identify a function state of a device coupled to a computer bus based on a feedback from the device, in accordance with various embodiments.

FIG. 5 illustrates an example apparatus suitable for use to practice various aspects of the present disclosure, in accordance with various embodiments.

FIG. 6 illustrates a storage medium having instructions for practicing methods described with reference to various figures herein, in accordance with various embodiments.

FIG. 7 illustrates an example process to be performed by a system driver to identify a function state of a device coupled to a computer bus based on a feedback from the device, in accordance with various embodiments.

### DETAILED DESCRIPTION

A computer bus may discover a device coupled to a computer bus, determine when the device is ready to be configured, perform resource allocation, and bind a specific device driver for the device. However, a computer bus, e.g. a peripheral component interconnect (PCI) bus, may have many problems, such as, little support for evaluating function states for devices coupled to the PCI bus, inconsistent and unreliable input/output (I/O) subsystem configuration, very little support for evaluating a state of a virtual device in a virtual machine (VM), and other performance and functional problems. Embodiments herein may provide mechanisms to addresses the shortcomings of a computer bus, such as a PCI bus, or other computer bus. Embodiments herein may be applicable to any computer bus, e.g., the PCI bus, or other computer bus, and devices from independent hardware vendors (IHV), operating system vendors (OSV), or virtual machine monitor (VMM) vendors.

In embodiments, a device coupled to a computer bus may include a function status register. The function status register may store information to indicate a function state of the device, where the function state may include more states than two states including a state ready for configuration, or a state not ready for configuration. In some embodiments, the function state may indicate the operations and stages of the device during an initialization or configuration process of the device. Furthermore, the function state in the function status register may be accessible, through a feedback mechanism, by a system driver executed by a processor coupled to the function status register through the computer bus. As a result, the device may communicate detailed function states with the system driver and the processor. A system driver may receive feedback from the function status register in the device after a notification from the device or after a polling by the system driver to the device, and further take appropriate action based on explicit knowledge of the function state of the device. In doing so, many problems for the PCI bus or other computer bus may be overcome. For example, embodiments herein may allow a system driver to improve boot/resume time based on explicit function state information from the device, instead of waiting for the expiration of a timer. The explicit function state may also provide flexibility to device developers to improve the speed at which the device becomes ready for use based on the statistical needs of the device's use model. Additional benefits may include: more robust operation for SSDs, support for evaluating a state of a virtual device in a VM, and other benefits.

In embodiments, an apparatus for computing may include a processor coupled to a computer bus. A system driver may be executed by the processor to identify a function state of a device based on a feedback from a function status register in the device, when the device is coupled to the processor through the computer bus, where the function state may be one of a plurality of function states of the device.

In embodiments, a device may include an interface to be coupled to a computer bus, and a function status register coupled to the interface. The function status register may store information to indicate a function state of the device, and the function state may be accessible by a processor coupled to the function status register through the computer bus.

In embodiments, an apparatus for computing may include a processor coupled to a computer bus, and a device coupled to the computer bus. A system driver may be executed by the processor to identify a function state of the device based on a feedback from a function status register in the device, where the function state may be one of a plurality of function states of the device.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

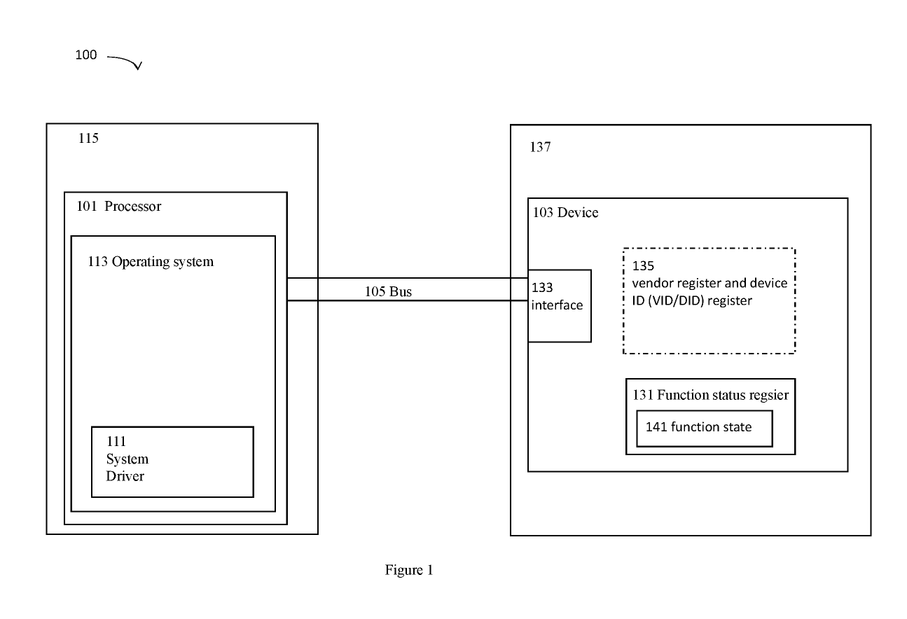

FIG. 1 illustrates an example apparatus 100 including a processor 101 coupled to a device 103 by a computer bus 105, and a system driver 111 to identify a function state 141 of the device 103 based on a feedback from the device 103, in accordance with various embodiments. For clarity, features of the apparatus 100 are described below as an example of an apparatus that may include a processor coupled to a device by a computer bus, and a system driver to identify a function state of the device based on a feedback from the device, e.g., from a function status register in the device. It is to be understood that there may be more or fewer components included in the apparatus 100. Further, it is to be understood that one or more of the devices and components within the apparatus 100 may include additional and/or varying features from the description below, and may include any device that one having ordinary skill in the art would consider and/or refer to as a processor, a device, a computer bus, and a system driver.

In embodiments, the apparatus 100 may include the processor 101 located in a printed circuit board (PCB) 115. An operating system 113 may operate on the processor 101, and may include the system driver 111. The device 103 may be located in a PCB 137. The device 103 may be coupled to the processor 101 by the computer bus 105. The device 103 may include an interface 133 coupled to the computer bus 105. The device 103 may also include a function status register 131 coupled to the interface 133. The function status register 131 may store information to indicate the function state 141 of the device 103, which may be simply referred to as the function state 141. In other words, the function state 141 may be one of the possible values the function status register 131 may include. In some embodiments, the function state 141 may be stored in a predetermined space in the function status register 131, and the function state 141 may be accessible by the processor 101 coupled to the function status register 131 through the computer bus 105. Additionally and alternatively, the device 103 may include a vendor register identification and a device identification (VID/DID) register 135 coupled to the interface 133 to store a vendor register identification and a device identification for the device 103.

In embodiments, the system driver 111 may be executed by the processor 101 to identify the function state 141 of the device 103 based on a feedback from the device 103, where the function state 141 may be stored in the function status register 131. The feedback from the device 103 may be received from a function status register in the device, and may be received after a notification from the device 103 or after a polling by the system driver 111 to the device 103.

In embodiments, the apparatus 100 may be any computing system, for example, a laptop computer, an ultra-laptop computer, a tablet, a touch pad, a portable computer, a handheld computer, a wearable device, a palmtop computer, a personal digital assistant (PDA), an e-reader, a cellular telephone, a combination cellular telephone/PDA, a mobile smart device (e.g., a smart phone, a smart tablet, etc.), a mobile internet device (MID), a mobile messaging device, a mobile data communication device, a mobile media playing device, a camera, a mobile gaming console, etc. In embodiments, the apparatus 100 may also be a non-mobile device that may include, but is not to be limited to, for example, a personal computer (PC), a television, a smart television, a data communication device, a media playing device, a gaming console, a gateway, an Internet of Things (IOT) device, etc. The apparatus 100 may include controllers (or processors) and other components that execute software and/or control hardware to execute local programs or consume services provided by external service providers over a network. For example, the apparatus 100 may include one or more software clients or applications that run locally and/or utilize or access web-based services (e.g., online stores or services, social networking services, etc.). The apparatus 100 may also, or instead, include a web interface running in a browser from which the electronic apparatus can access such web-based services. The apparatus 100 may also include storage devices to store logic and data associated with the programs and services used by the apparatus 100.

In embodiments, the apparatus 100 may include the processor 101 located on the PCB 115, and the device 103 located on the PCB 137. The PCB 115 may be the same PCB as the PCB 137. In some other embodiments, the PCB 115 may be a PCB different from the PCB 137. In embodiments, the PCB 115 may mechanically support and electrically connect electronic components, e.g., the processor 101, using conductive tracks, pads and other features etched from copper sheets or other metal sheets laminated onto a non-conductive substrate. In embodiments, the PCB 115 may be a motherboard with expansion capability so that various components or packages may be attached to the PCB. For example, circuit packages attached to the PCB 115 may include peripherals, interface cards, TV tuner cards, or cards providing extra USB or FireWire slots. The PCB 115 may also include daughter cards attached to the PCB 115, where the daughter cards may include sound cards, video cards, network cards, hard drives, or other forms of persistent storage, or a variety of other custom components or packages. In some embodiments, the PCB 115 may be a mainboard, which may be a single board with limited or no additional expansion capability, such as controlling boards in laser printers, televisions, washing machines, or other embedded systems with limited expansion abilities. In embodiments, the PCB 115 may be a single sided board with one metal layer, a double-sided board with two metal layers, or a multi-layer board with outer and inner layers. In embodiments, the PCB 115 may be a multi-layer board including a plurality of layers, such as a ground layer, a dielectric layer, a metal layer, a power layer, or a signal layer, and other metal layers. In embodiments, the PCB 137 may be similar to the PCB 115.

In embodiments, the processor 101 may be a central processing unit (CPU). In some embodiments, the processor 101 may be a programmable device that may execute a program, e.g., the system driver 111. In embodiments, the processor 101 may be a microcontroller, a 16-bit processor, a 32-bit processor, a 64-bit processor, a single core processor, a multi-core processor, a digital signal processor, an embedded processor, or any other processor.

In embodiments, the operating system 113 may be any system software that manages hardware or software resources for the apparatus 100, and may provide services to applications, e.g., the system driver 111. The operating system 113 may be Windows®, Android OS, iOS, Linux, a real-time operating system (RTOS), an automotive infotainment operating system, among others. For example, the operating system 113 may be a real-time operating system such as VxWorks, PikeOS, eCos, QNX, MontaVista Linux, RTLinux, Windows CE, or other operating system.

In embodiments, the computer bus 105 may be an external computer bus, an internal computer bus, a serial computer bus, or a parallel computer bus. For example, the computer bus 105 may be a PCI bus, a PCI Extended bus (PCI-X), a PCI express bus, a universal serial bus (USB), a parallel advanced technology attachment (PATA) bus, a serial ATA (SATA) bus, an inter-integrated circuit (I²C) bus, an IEEE 1394 interface (FireWire) bus, a small computer system interface (SCSI) bus, a scalable coherent interface (SCI) bus, or other computer bus.

In embodiments, the device 103 may be any piece of computer hardware. For example, the device 103 may be a network interface card, an audio card, a video controller, an Ethernet controller, a webcam, mouse, a Bluetooth controller, a PCI to ISA bridge, a GUI Accelerator, an ATM Controller, a multimedia card, a SCSI controller, a multimedia device, a MPEG-II Video Decoder, or any input/output device. In embodiments, the device 103 may be a PCI device, which may be plugged directly into a PCI slot on a computer's motherboard, e.g., the PCB 115. In some other embodiments, the device 103 may be coupled to the processor 101 by a different computer bus.

In embodiments, the device 103 may be in various state as represented by the function state 141. For example, the function state 141 may be one selected from a not-ready state, a ready for system configuration state, a configuration in progress state, a ready for device specific configuration state, a ready run state, a run wait state, or a malfunction state. In some other embodiments, the function state 141 may be in states with different names. For example, the function state 141 may include multiple states named by numeral values, e.g., state 0, state 1, state 2, and more. Traditionally, the computer bus 105, e.g., a PCI bus, may only provide simple states for a device coupled to the PCI bus, either ready for configuration, or not ready for configuration, without providing more information for system driver to distinguish between detailed states. Embodiments herein provide the function state 141 with more than two possible values. In addition, the function state 141 of the device 103 may be provided to the system driver 111 by a feedback from the device 103 so that the system driver 111 may take appropriate actions based on the function state 141 of the device 103.

In embodiments, the system driver 111 may receive a feedback from the device 103 after a notification from the device 103, or after a polling by the system driver 111 to the device 103. The system driver 111 may identify the function state 141 of the device 103 based on a feedback from the device 103. The system driver 111 may further configure the device 103 for system functions when the device 103 is identified to be in a ready for system configuration state. The system driver 111 may further configure the device 103 for device specific functions when the device 103 is identified to be in a ready for device specific configuration state. The system driver 111 may further identify a vendor register identification and a device identification (VID/DID) after the device is identified to be in or beyond a ready for system configuration state. In addition, the system driver 111 may perform initial setup the device 103, such as setup an address and communication protocols for the device 103, and handle device specific drive for the device 103.

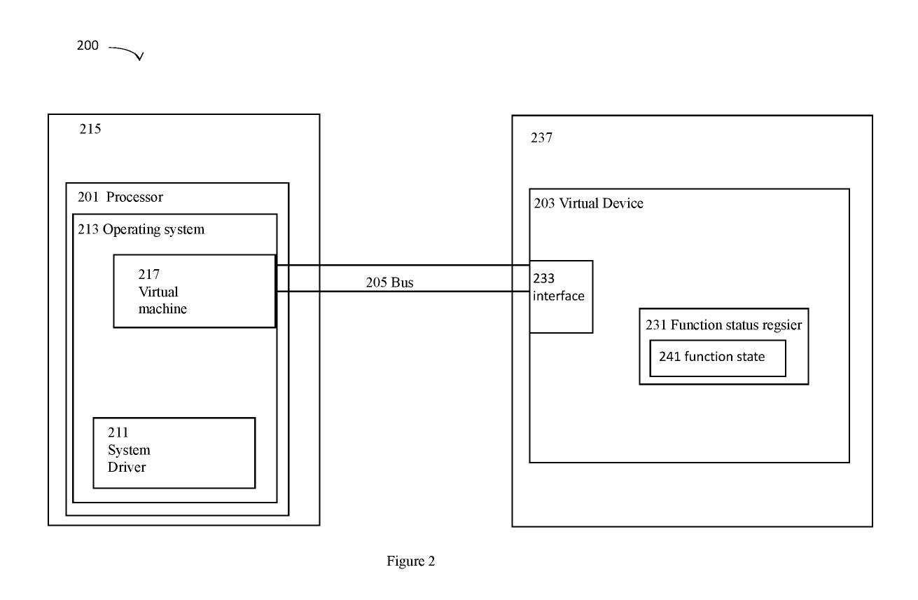

FIG. 2 illustrates another example apparatus 200 including a processor 201 coupled to a virtual device 203 by a computer bus 205, and a system driver 211 to identify a function state 241 of the virtual device 203 based on a feedback from the virtual device 203, in accordance with various embodiment. In embodiments, the apparatus 200, the processor 201, the system driver 211, and the bus 205, may be similar to the apparatus 100, the processor 101, the system driver 111, and the bus 105, shown in FIG. 1. The detailed description for each part of the apparatus 200 may be similar to the description of a similar part for the apparatus 100.

In embodiments, the apparatus 200 may include the processor 201 located in a PCB 215. An operating system 213 may operate on the processor 201, and may include the system driver 211. In addition, the operating system 213 may include a VM 217. In embodiments, the VM 217 may be an emulation of a computer system to provide functionality of a physical computer or machine. The VM 217 may be a VM to provide a substitute for a real machine and may be implemented based on the processor 201, any other specialized hardware, software, or a combination. In some embodiments, the VM 217 may be an operating-system-level VM, where multiple isolated and secure VMs may run on the same processor 201. In some other embodiments, the VM 217 may be a system level VM to provide functionality to execute entire operating systems. For example, the VM 217 may be a hypervisor that uses native execution to share and manage hardware, allowing for multiple environments that are isolated from one another, yet exist on the same physical machine, e.g., the processor 201. In some other embodiments, the VM 217 may be a process virtual machine to execute computer programs, e.g., the system driver 211, in a platform-independent environment.

In embodiments, the device 203 located in a PCB 237 may be a virtual device, which may be treated as a device, as far as user level software is concerned, but is generated by the kernel without reference to hardware. The device 203 may be coupled to the VM 217 or the processor 201 by the computer bus 205. The device 203 may include an interface 233 coupled to the computer bus 205. The device 203 may also include a function status register 231 coupled to the interface 233. The function status register 231 may store information to indicate the function state 241 of the device 203. In some embodiments, the function state 241 may be stored in a predetermined space in the function status register 231, and the function state 241 may be accessible by the processor 201 or the VM 217 coupled to the function status register 231 through the computer bus 205.

In embodiments, the system driver 211 may be executed by the processor 201 or the VM 217 to identify the function state 241 of the device 203 based on a feedback from the device 203, where the function state 241 may be stored in the function status register 231. The feedback from the device 203 may be received after a notification from the device 203 or after a polling by the system driver 211 to the device 203.

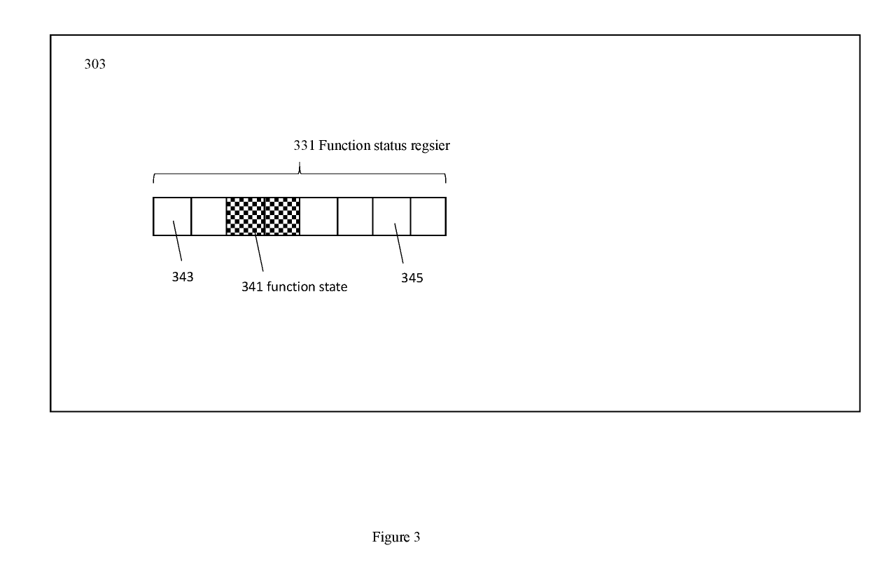

FIG. 3 illustrates an example function status register 331 of a device 303 to store information to indicate a function state 341 of the device 303 coupled to a computer bus, in accordance with various embodiments. The device 303 may be an example of the device 103, the function status register 331 may be an example of the function status register 131, and the function state 341 may be an example of the function state 141, as shown in FIG. 1. Similarly, the device 303 may be an example of the device 203, the function status register 331 may be an example of the function status register 231, and the function state 341 may be an example of the function state 241, as shown in FIG. 2.

In embodiments, the function status register 331 may include multiple bits having one or more bytes, e.g., 4 bits, 6 bits, 7 bits, 8 bits, 16 bits, 32 bits, 64 bits, or more. The function status register 331 may include multiple fields, such as the function state 341. In addition, the function status register 331 may include some other operational state field, e.g., a filed 343. For example, the field 343 may include information to indicate detected parity error, signaled system error, received maser abort, received target abort, signaled target abort, master data parity error, interrupt status, capabilities list, immediate readiness. In comparison, the filed 343 may be used for indicating information during the operation of the device 303, while the function state 341 may be used to indicate the initialization or configuration of the device 303, before the device 303 is operational for its desired objectives. In some embodiments, the function status register 331 may include some predetermined field that may be used for future system development, e.g., a field 345. Furthermore, the function status register 331 may include various information, such as device identification, vendor identification, revision identification, and other supplementary information for the operation of the device 303, not shown.

The function state 341, the field 343, and the field 345 may be located in various positions of the function status register 331. In some embodiments, the function state 341 may be located at the beginning or the end of the function status register 331. When the device 303 is a PCI device, the function state 341 may be bit 1, bit 2, and bit 6 of the function status register 331. In some other embodiments, the function state 341 may be located at a position not at the beginning or the end of the function status register 331.

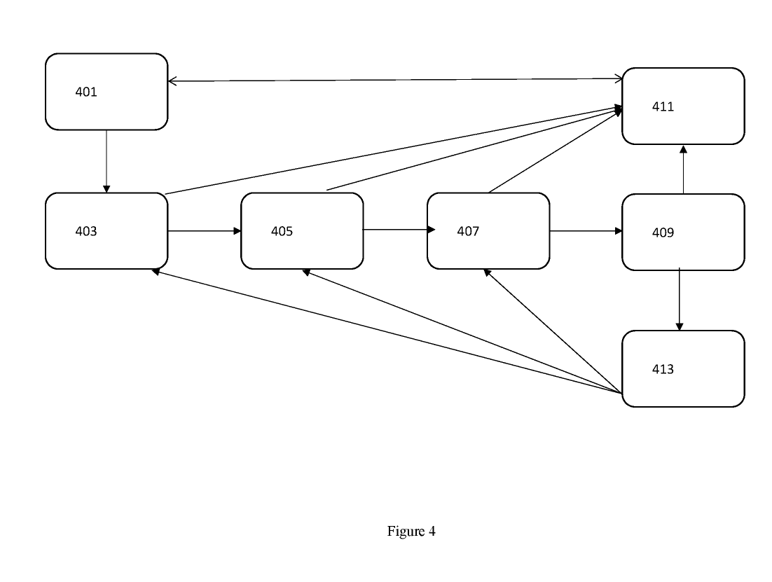

FIG. 4 illustrates an example state diagram 400 of operations to be performed by a system driver to identify a function state of a device coupled to a computer bus based on a feedback from the device, in accordance with various embodiments. In embodiments, operations of the state diagram 400 may be performed by the system driver 111 to identify the function state 141 of the device 103 coupled to the computer bus 105 as shown in FIG. 1. Similarly, operations of the state diagram 400 may be performed by the system driver 211 to identify the function state 241 of the device 203 coupled to the computer bus 205 as shown in FIG. 2. The operations of the state diagram 400 may be described using the system driver 111 and the device 103 as an example, and may be applicable to any other system driver and device.

In embodiments, the state diagram 400 may include a state 401, a state 403, a state 405, a state 407, a state 409, a state 411, and a state 413. The multiple states, e.g., the state 401, the state 403, the state 405, the state 407, the state 409, the state 411, and the state 413 may be numeral numbers used to represent various stages of a device, e.g., the device 103, being initialized or configured. In some other embodiments, the multiple states may have a name indicating the stage of the initialization. For example, the state 401 may be a not-ready state (NOTRDY), the state 403 may be a ready for system configuration state (CFGRDY), the state 405 may be a configuration in progress state (CFGING), the state 407 may be a ready for device specific configuration state (FN_SPC), the state 409 may be a ready run state (RUN), the state 411 may be a malfunction state (MAL), and the state 413 may be a run wait state (RUNWAIT). The names of the states presented herein may be for examples only, and are not limiting to any specific names to be used for the function state 141, the function state 241, or the function state 341.

In embodiments, the state 401 may be an initial state. For example, the device 103 may be in a not-ready state at the state 401 following operations for reset or start up, indicating the device 103 may be in a process of self-initialization, not ready for configuration by the system driver 111.

Afterwards, the device 103 may move forward to the state 403, which may be a ready for system configuration state for the device 103. The device 103 may enter the ready for system configuration state once the device 103 has performed self-initialization and may be ready for configuration by the system driver 111. At the state 403, the system driver 111 may configure the device 103 for system functions when the device 103 is identified to be in a ready for system configuration state.

Afterwards, the device 103 may move forward to the state 405, which may be a configuration in progress state for the device 103. During the state 405, a configuration in progress state, the system driver 111 may configure the device 103 for system functions, such as determination of protocol between the device 103 and the computer bus 105, resource allocation, and general system configuration for the device 103.

Afterwards, the device 103 may move forward to the state 407, which may be a ready for device specific configuration state for the device 103. At the state 407, the system driver 111 may configure the device 103 for device specific functions, such as binding a specific device driver, when the device 103 is identified to be in a ready for device specific configuration state.

Afterwards, the device 103 may move forward to the state 409, which may be a ready run state for the device 103, when the device 103 may perform its intended functions.

In embodiments, when the device 103 is in any of the state, e.g., the state 401, the state 403, the state 405, the state 407, the state 409, the device 103 may move to the state 411, which may be a malfunction state, when certain error or unexpected situation happens to the device 103. The malfunction may be caused by improper operation, receipt of an illegal descriptor/command, or unknown errors. When the device 103 may be in a malfunction state, e.g., the state 411, the device 103 may move to the initial state, e.g., the state 401 to restart the operations.

In embodiments, when the device 103 is in a ready run state, e.g., the state 409, and may be idle for a period of time, which may be a predefined period of time, the device 103 may move a run wait state, e.g., the state 413, to save energy and vacant any resource the device 103 may be using. When the device 103 is in the run wait state, e.g., the state 413, the device 103 may move to any of the states for configuration, e.g., the state 403, the state 405, the state 407, and the state 409.

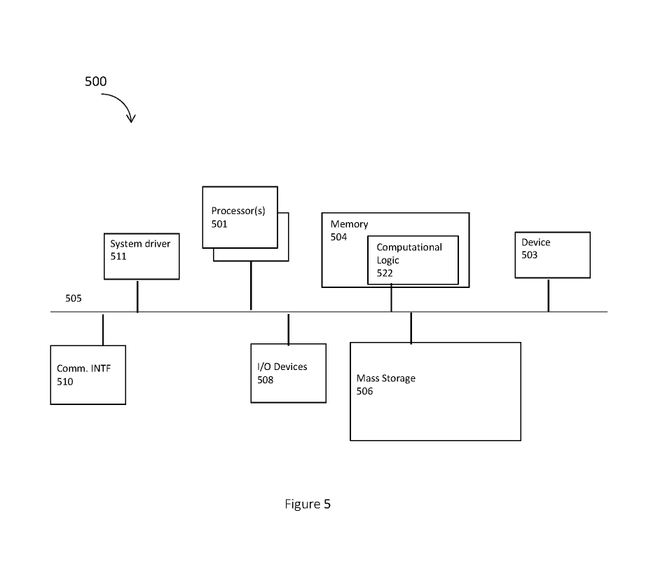

FIG. 5 illustrates an example apparatus 500 suitable for use to practice various aspects of the present disclosure, in accordance with various embodiments. As shown, the apparatus 500 may include a processor 501, a device 503, a system memory 504, a mass storage 506, an I/O device 508, a communication interface 510, coupled together by a computer bus 505. A system driver 511 may be executed by the processor 501 to identify a function state of the device 503 based on a feedback from the device 503. In some embodiments, the processor 501, the device 503, the computer bus 505, and the system driver 511 may be an example of the processor 101, the device 103, the computer bus 105, and the system driver 111, shown in FIG. 1. In addition, the system memory 504, the mass storage 506, the I/O device 508, and the communication interface 510, coupled to the computer bus 505, may be further examples of the device 103 coupled to the computer bus 105 as shown in FIG. 1.

The processor 501 may include any type of processors, such as a CPU, a microprocessor, and the like. The processor 501 may be implemented as an integrated circuit having multi-cores, e.g., a multi-core microprocessor. The apparatus 500 may include the mass storage devices 506 (such as diskette, hard drive, volatile memory (e.g., dynamic random-access memory (DRAM), compact disc read-only memory (CD-ROM), digital versatile disk (DVD), and so forth). In general, the system memory 504 and/or the mass storage devices 506 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth. The processor 501, the mass storage 506 and/or the system memory 504 may together or separately be considered to be, or implement, the system driver 511 in whole or in part.

The apparatus 500 may further include I/O devices 508 (such as a display (e.g., a touchscreen display), keyboard, cursor control, remote control, gaming controller, image capture device, and so forth) and communication interfaces 510 (such as network interface cards, modems, infrared receivers, radio receivers (e.g., Bluetooth), and so forth).

The communication interfaces 510 may include communication chips (not shown) that may be configured to operate the apparatus 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments. In some embodiments, the communication interfaces 510 may be, may include, and/or may be coupled with the EC and/or TCPM as described herein.

The above-described apparatus 500 elements may be coupled to each other via the computer bus 505, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions for the operation of various components of apparatus 500, including but not limited to an operating system of apparatus 500 and/or one or more applications. The various elements may be implemented by assembler instructions supported by the processor 501 or high-level languages that may be compiled into such instructions.

The permanent copy of the programming instructions may be placed into mass storage devices 506 in the factory, or in the field through, for example, a distribution medium (not shown), such as a compact disc (CD), or through communication interface 510 (from a distribution server (not shown)). That is, one or more distribution media having an implementation of the agent program may be employed to distribute the agent and to program various computing devices.

The number, capability, and/or capacity of the elements 506, 508, 510 may vary, depending on whether the apparatus 500 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, memory 504 may include computational logic 522 configured to implement various firmware and/or software services associated with operations of the apparatus 500. For some embodiments, the processor 501 may be packaged together with computational logic 522 configured to practice aspects of embodiments described herein to form a system in package (SiP) or a SoC.

In various implementations, the apparatus 500 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the apparatus 500 may be any other electronic device that processes data. In some embodiments certain elements such as the BIOS, USB-C, embedded processors are described as related to specific elements of FIG. 5, while in other embodiments one or more of the various elements may be related to different elements of FIG. 5.

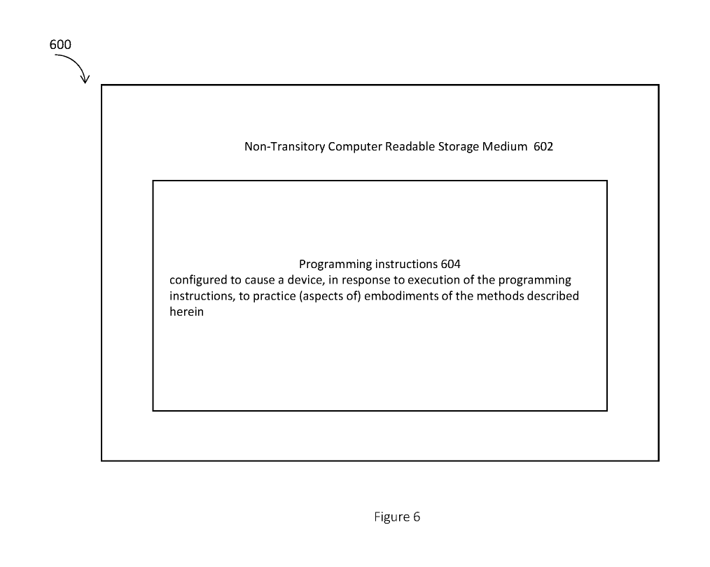

Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., the apparatus 500 or the apparatus 100, in response to execution of the programming instructions, to perform, e.g., various operations associated with the system driver 111 shown in FIG. 1. For example, programming instructions 604 may be configured to enable the apparatus 100, in response to execution of the programming instructions 604, to perform various operations illustrated in the state diagram 400 in FIG. 4 for the system driver 111.

In alternate embodiments, programming instructions 604 may be disposed on multiple computer-readable non-transitory storage media 602 instead. In alternate embodiments, programming instructions 604 may be disposed on computer-readable transitory storage media 602, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

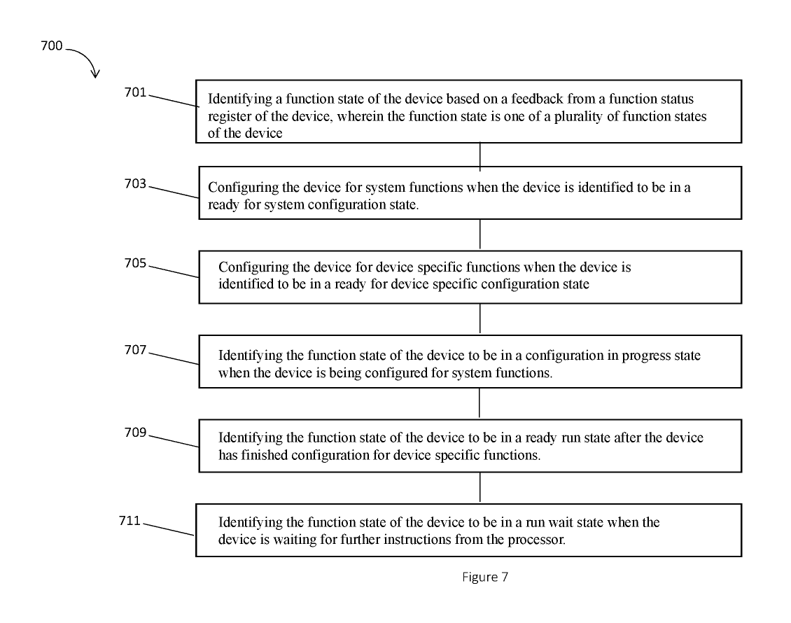

FIG. 7 illustrates an example process 700 to be performed by a system driver to identify a function state of a device coupled to a computer bus based on a feedback from the device, in accordance with various embodiments. In embodiments, the process 700 may be performed by the system driver 111 to identify the function state 141 of the device 103 coupled to the computer bus 105 as shown in FIG. 1. Similarly, the process 700 may be performed by the system driver 211 to identify the function state 241 of the device 203 coupled to the computer bus 205 as shown in FIG. 2. The process 700 may be described using the system driver 111 and the device 103 as an example, and may be applicable to any other system driver and device.

The process 700 may start at an interaction 701. During the interaction 701, a system driver may identify a function state of the device based on a feedback from a function status register of the device, wherein the function state is one of a plurality of function states of the device.

During an interaction 703, the system driver may configure the device for system functions when the device is identified to be in a ready for system configuration state.

During an interaction 705, the system driver may configure the device for device specific functions when the device is identified to be in a ready for device specific configuration state.

During an interaction 707, the system driver may identify the function state of the device to be in a configuration in progress state when the device is being configured for system functions.

During an interaction 709, the system driver may identify the function state of the device to be in a ready run state after the device has finished configuration for device specific functions.

During an interaction 709, the system driver may identify the function state of the device to be in a run wait state when the device is waiting for further instructions from the processor.

### EXAMPLES

Example 1 may include an apparatus for computing, comprising: a processor coupled to a computer bus; and a system driver to be executed by the processor to identify a function state of a device based on a feedback from a function status register in the device, when the device is coupled to the processor through the computer bus, wherein the function state is one of a plurality of function states of the device.

Example 2 may include the apparatus of example 1 and/or some other examples herein, wherein the processor is affixed with a first printed circuit board (PCB), and the device is affixed with a second PCB different from the first PCB.

Example 3 may include the apparatus of example 1 and/or some other examples herein, wherein the feedback from the function status register in the device is received after a notification from the device or after a polling by the system driver to the device.

Example 4 may include the apparatus of example 1 and/or some other examples herein, wherein the function state of the device is stored in a predetermined space of the function status register in the device.

Example 5 may include the apparatus of any of examples 1-4 and/or some other examples herein, wherein the device is a virtual device.

Example 6 may include the apparatus of any of examples 1-4 and/or some other examples herein, wherein the function state is one selected from a not-ready state, a ready for system configuration state, a configuration in progress state, a ready for device specific configuration state, a ready run state, a run wait state, or a malfunction state.

Example 7 may include the apparatus of any of examples 1-4 and/or some other examples herein, wherein the system driver is further to identify a vendor register identification and a device identification (VID/DID) after the device is identified to be in or beyond a ready for system configuration state.

Example 8 may include the apparatus of any of examples 1-4 and/or some other examples herein, wherein the system driver is further to configure the device for system functions when the device is identified to be in a ready for system configuration state.

Example 9 may include the apparatus of any of examples 1-4 and/or some other examples herein, wherein the system driver is further to configure the device for device specific functions when the device is identified to be in a ready for device specific configuration state.

Example 10 may include the apparatus of any of examples 1-4 and/or some other examples herein, wherein the computer bus is a peripheral component interconnect (PCI) bus, a PCI Extended bus (PCI-X), a PCI express bus, a serial bus, or an external computer bus.

Example 11 may include a device for computing, comprising: an interface to be coupled to a computer bus; and a function status register coupled to the interface, wherein the function status register stores information to indicate a function state of the device, the function state is one of a plurality of function states of the device, and wherein the function state is accessible by a processor coupled to the function status register through the computer bus.

Example 12 may include the device of example 11 and/or some other examples herein, further comprising: a vendor register identification and a device identification (VID/DID) register coupled to the interface to store a vendor register identification and a device identification.

Example 13 may include the device of any of examples 11-12 and/or some other examples herein, wherein the function state is one selected from a not-ready state, a ready for system configuration state, a configuration in progress state, a ready for device specific configuration state, a ready run state, a run wait state, or a malfunction state.

Example 14 may include the device of any of examples 11-12 and/or some other examples herein, wherein the device is to be configured for system functions by the processor when the device is identified to be in a ready for system configuration state.

Example 15 may include the device of any of examples 11-12 and/or some other examples herein, wherein the function status register is to indicate that the device is in a configuration in progress state when the device is being configured for system functions.

Example 16 may include the device of any of examples 11-12 and/or some other examples herein, wherein the device is to be configured for device specific functions when the device is identified to be in a ready for device specific configuration state.

Example 17 may include the device of any of examples 11-12 and/or some other examples herein, wherein the function status register is to indicate that the device is in a ready run state after the device has finished configuration for device specific functions.

Example 18 may include the device of any of examples 11-12 and/or some other examples herein, wherein the function status register is to indicate that the device is in a run wait state when the device is waiting for further instructions from the processor.

Example 19 may include an apparatus for computing, comprising: a processor coupled to a computer bus; a device coupled to the computer bus; and a system driver to be executed by the processor to identify a function state of the device based on a feedback from a function status register in the device, wherein the function state is one of a plurality of function states of the device.

Example 20 may include the apparatus of example 19 and/or some other examples herein, wherein the feedback from the function status register in the device is received after a notification from the device or after a polling by the system driver to the device.

Example 21 may include the apparatus of any of examples 19-20 and/or some other examples herein, wherein the function state of the device is stored in a predetermined space of the function status register in the device.

Example 22 may include the apparatus of any of examples 19-20 and/or some other examples herein, wherein the device is a virtual device.

Example 23 may include the apparatus of any of examples 19-20 and/or some other examples herein, wherein the function state is one selected from a not-ready state, a ready for system configuration state, a configuration in progress state, a ready for device specific configuration state, a ready run state, a run wait state, or a malfunction state.

Example 24 may include the apparatus of any of examples 19-20 and/or some other examples herein, wherein the system driver is further to identify a vendor register identification and a device identification (VID/DID) after the device is identified to be in or beyond a ready for system configuration state.

Example 25 may include the apparatus of any of examples 19-20 and/or some other examples herein, wherein the computer bus is a peripheral component interconnect (PCI) bus, a PCI Extended bus (PCI-X), a PCI express bus, a serial bus, or an external computer bus.

Example 26 may include a method for a processor coupled to a device through a computer bus, comprising: identifying a function state of the device based on a feedback from a function status register of the device, wherein the function state is one of a plurality of function states of the device; and configuring the device for system functions when the device is identified to be in a ready for system configuration state.

Example 27 may include the method of example 26 and/or some other examples herein, wherein the function state is one selected from a not-ready state, a ready for system configuration state, a configuration in progress state, a ready for device specific configuration state, a ready run state, a run wait state, or a malfunction state.

Example 28 may include the method of example 26 and/or some other examples herein, wherein the computer bus is a peripheral component interconnect (PCI) bus, a PCI Extended bus (PCI-X), a PCI express bus, a serial bus, or an external computer bus.

Example 29 may include the method of any of examples 26-28 and/or some other examples herein, further comprising: configuring the device for device specific functions when the device is identified to be in a ready for device specific configuration state.

Example 30 may include the method of any of examples 26-28 and/or some other examples herein, further comprising: identifying the function state of the device to be in a configuration in progress state when the device is being configured for system functions.

Example 31 may include the method of any of examples 26-28 and/or some other examples herein, further comprising: identifying the function state of the device to be in a ready run state after the device has finished configuration for device specific functions.

Example 32 may include the method of any of examples 26-28 and/or some other examples herein, further comprising: identifying the function state of the device to be in a run wait state when the device is waiting for further instructions from the processor.

Example 33 may include one or more computer-readable media having instructions for a processor coupled to a device through a computer bus, upon execution of the instructions by the processor, to perform the method of any one of examples 26-32.

Example 34 may include an apparatus for a processor coupled to a device through a computer bus, comprising: means for identifying a function state of the device based on a feedback from a function status register of the device, wherein the function state is one of a plurality of function states of the device; and means for configuring the device for system functions when the device is identified to be in a ready for system configuration state.

Example 35 may include the apparatus of example 34 and/or some other examples herein, wherein the function state is one selected from a not-ready state, a ready for system configuration state, a configuration in progress state, a ready for device specific configuration state, a ready run state, a run wait state, or a malfunction state.

Example 36 may include the apparatus of example 34 and/or some other examples herein, wherein the computer bus is a peripheral component interconnect (PCI) bus, a PCI Extended bus (PCI-X), a PCI express bus, a serial bus, or an external computer bus.

Example 37 may include the apparatus of any of examples 34-36 and/or some other examples herein, further comprising: means for configuring the device for device specific functions when the device is identified to be in a ready for device specific configuration state.

Example 38 may include the apparatus of any of examples 34-36 and/or some other examples herein, further comprising: means for identifying the function state of the device to be in a configuration in progress state when the device is being configured for system functions.

Example 39 may include the apparatus of any of examples 34-36 and/or some other examples herein, further comprising: means for identifying the function state of the device to be in a ready run state after the device has finished configuration for device specific functions.

Example 40 may include the apparatus of any of examples 34-36 and/or some other examples herein, further comprising: means for identifying the function state of the device to be in a run wait state when the device is waiting for further instructions from the processor.

Example 41 may include an apparatus comprising: means to identify a value of a register associated with a peripheral component interconnect (PCI)/PCI express (PCIe) function; and means to identify, based on the value of the register, an operational state of the function.

Example 42 may include the apparatus of example 41 or some other example herein, wherein the function is related to a device coupled with the apparatus via a PCI or PCIe connection.

Example 43 may include the apparatus of example 41 or some other example herein, wherein the function includes multiple operational states; and wherein the value of the register is readable in all operational states of the function.

Example 44 may include the apparatus of example 41 or some other example herein, wherein the value is a value of a function status field associated with the register.

Example 45 may include the apparatus of example 41 or some other example herein, wherein the register is a PCI status register.

Example 46 may include the apparatus of example 41 or some other example herein, wherein the operational state is NOTRDY, CFGRDY, CFGING, FN_SPC, RUN, RUNWAIT, or MAL as depicted in Table 1 above.

Example 47 may include one or more non-transitory computer-readable media comprising instructions to cause a computing device, when executed by one or more processors of the computing device, to: identify a value of a register associated with a peripheral component interconnect (PCI)/PCI express (PCIe) function; and identify, based on the value of the register, an operational state of the function.

Example 48 may include the one or more non-transitory computer-readable media of example 47 or some other example herein, wherein the function is related to a device coupled with the computing device via a PCI or PCIe connection.

Example 49 may include the one or more non-transitory computer-readable media of example 47 or some other example herein, wherein the function includes multiple operational states; and wherein the value of the register is readable in all operational states of the function.

Example 50 may include the one or more non-transitory computer-readable media of example 47 or some other example herein, wherein the value is a value of a function status field associated with the register.

Example 51 may include the one or more non-transitory computer-readable media of example 47 or some other example herein, wherein the register is a PCI status register.

Example 52 may include the one or more non-transitory computer-readable media of example 47 or some other example herein, wherein the operational state is NOTRDY, CFGRDY, CFGING, FN_SPC, RUN, RUNWAIT, or MAL as depicted in Table 1 above.

Example 53 may include a method comprising: identifying or causing to identify a value of a register associated with a peripheral component interconnect (PCI)/PCI express (PCIe) function; and identifying or causing to identify, based on the value of the register, an operational state of the function.

Example 54 may include the method of example 53 or some other example herein, wherein the function is related to a device coupled with a computing system via a PCI or PCIe connection.

Example 55 may include the method of example 53 or some other example herein, wherein the function includes multiple operational states; and wherein the value of the register is readable in all operational states of the function.

Example 56 may include the method of example 53 or some other example herein, wherein the value is a value of a function status field associated with the register.

Example 57 may include the method of example 53 or some other example herein, wherein the register is a PCI status register.

Example 58 may include the method of example 53 or some other example herein, wherein the operational state is NOTRDY, CFGRDY, CFGING, FN_SPC, RUN, RUNWAIT, or MAL as depicted in Table 1 above.

Example 59 may include a system comprising: a device; and a processor communicatively coupled with the device via a peripheral component interconnect (PCI)/PCI express (PCIe) connection, the processor to: identify a value of a register associated with a PCI/PCIe function related to the device; and identify, based on the value of the register, an operational state of the function.

Example 60 may include the system of example 59 or some other example herein, wherein the function includes multiple operational states; and wherein the value of the register is readable in all operational states of the function.

Example 61 may include the system of example 59 or some other example herein, wherein the value is a value of a function status field associated with the register.

Example 62 may include the system of example 59 or some other example herein, wherein the register is a PCI status register.

Example 63 may include the system of example 59 or some other example herein, wherein the operational state is NOTRDY, CFGRDY, CFGING, FN_SPC, RUN, RUNWAIT, or MAL as depicted in Table 1 above.

Example 64 may include a method to determine the state of a Function based on the ability to complete a read of a specific register associated with the Function.

Example 65 may include the method of example 64 or some other example herein, with the specific register being readable in all operational states of the Function.

Example 66 may include the method of example 64 or some other example herein, with a Function status field associated with the specific register.

Example 67 may include the method of example 66 or some other example herein, with the specific register being the PCI Status Register.

Example 68 may include the method of example 65 or some other example herein, with a defined state encoding meaning NOTRDY, CFGRDY, CFGING, FN_SPC, RUN, RUNWAIT, or MAL as depicted in Table 1 above.

Example 69 may include an apparatus comprising means to perform one or more elements of a method described in or related to any of examples 1-68, or any other method or process described herein.

Example 70 may include one or more non-transitory computer-readable media comprising instructions to cause an electronic device, upon execution of the instructions by one or more processors of the electronic device, to perform one or more elements of a method described in or related to any of examples 1-68, or any other method or process described herein.

Example 71 may include an apparatus comprising logic, modules, or circuitry to perform one or more elements of a method described in or related to any of examples 1-68, or any other method or process described herein.

Example 72 may include a method, technique, or process as described in or related to any of examples 1-68, or portions or parts thereof.

Example 73 may include an apparatus comprising: one or more processors and one or more computer readable media comprising instructions that, when executed by the one or more processors, cause the one or more processors to perform the method, techniques, or process as described in or related to any of examples 1-68, or portions thereof.

Example 74 may include a signal as described in or related to any of examples 1-68, or portions or parts thereof.

Example 75 may include a signal in a wireless network as shown and described herein.

Example 76 may include a method of communicating in a wireless network as shown and described herein.

Example 77 may include a system for providing wireless communication as shown and described herein.

Example 78 may include a device for providing wireless communication as shown and described herein.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus for computing, comprising:
a processor coupled to a computer bus; and
a system driver to be executed by the processor to identify a function state of a device based on a feedback from a function status register in the device, when the device is coupled to the processor through the computer bus, wherein the function state is one of a plurality of function states of the device.

2. The apparatus of claim 1, wherein the processor is affixed with a first printed circuit board (PCB), and the device is affixed with a second PCB different from the first PCB.

3. The apparatus of claim 1, wherein the feedback from the function status register in the device is received after a notification from the device or after a polling by the system driver to the device.

4. The apparatus of claim 1, wherein the function state of the device is stored in a predetermined space of the function status register in the device.

5. The apparatus of claim 1, wherein the device is a virtual device.

6. The apparatus of claim 1, wherein the function state is one selected from a not-ready state, a ready for system configuration state, a configuration in progress state, a ready for device specific configuration state, a ready run state, a run wait state, or a malfunction state.

7. The apparatus of claim 1, wherein the system driver is further to identify a vendor register identification and a device identification (VID/DID) after the device is identified to be in or beyond a ready for system configuration state.

8. The apparatus of claim 1, wherein the system driver is further to configure the device for system functions when the device is identified to be in a ready for system configuration state.

9. The apparatus of claim 1, wherein the system driver is further to configure the device for device specific functions when the device is identified to be in a ready for device specific configuration state.

10. The apparatus of claim 1, wherein the computer bus is a peripheral component interconnect (PCI) bus, a PCI Extended bus (PCI-X), a PCI express bus, a serial bus, or an external computer bus.

11. A device for computing, comprising:
an interface to be coupled to a computer bus; and
a function status register coupled to the interface, wherein the function status register stores information to indicate a function state of the device, the function state is one of a plurality of function states of the device, and wherein the function state is accessible by a processor coupled to the function status register through the computer bus.

12. The device of claim 11, further comprising:
a vendor register identification and a device identification (VID/DID) register coupled to the interface to store a vendor register identification and a device identification.

13. The device of claim 11, wherein the function state is one selected from a not-ready state, a ready for system configuration state, a configuration in progress state, a ready for device specific configuration state, a ready run state, a run wait state, or a malfunction state.

14. The device of claim 11, wherein the device is to be configured for system functions by the processor when the device is identified to be in a ready for system configuration state.

15. The device of claim 11, wherein the function status register is to indicate that the device is in a configuration in progress state when the device is being configured for system functions.

16. The device of claim 11, wherein the device is to be configured for device specific functions when the device is identified to be in a ready for device specific configuration state.

17. The device of claim 11, wherein the function status register is to indicate that the device is in a ready run state after the device has finished configuration for device specific functions.

18. The device of claim 11, wherein the function status register is to indicate that the device is in a run wait state when the device is waiting for further instructions from the processor.

19. An apparatus for computing, comprising:
a processor coupled to a computer bus;
a device coupled to the computer bus; and
a system driver to be executed by the processor to identify a function state of the device based on a feedback from a function status register in the device, wherein the function state is one of a plurality of function states of the device.

20. The apparatus of claim 19, wherein the feedback from the function status register in the device is received after a notification from the device or after a polling by the system driver to the device.

21. The apparatus of claim 19, wherein the function state of the device is stored in a predetermined space of the function status register in the device.

22. The apparatus of claim 19, wherein the device is a virtual device.

23. The apparatus of claim 19, wherein the function state is one selected from a not-ready state, a ready for system configuration state, a configuration in progress state, a ready for device specific configuration state, a ready run state, a run wait state, or a malfunction state.

24. The apparatus of claim 19, wherein the system driver is further to identify a vendor register identification and a device identification (VID/DID) after the device is identified to be in or beyond a ready for system configuration state.

25. The apparatus of claim 19, wherein the computer bus is a peripheral component interconnect (PCI) bus, a PCI Extended bus (PCI-X), a PCI express bus, a serial bus, or an external computer bus.
